(19) United States
(12) Patent Application Publication
(10) Pub. No.: US 2012/0235914 A1
(43) Pub. Date: Sep. 20, 2012

(54) MONITOR

(76) Inventors: Yu-Ming Hsu, Taipei City (TW); Chien-Jui Wang, Taipei City (TW)

(21) Appl. No.: 13/239,412

(22) Filed: Sep. 22, 2011

(30) Foreign Application Priority Data
Mar. 18, 2011 (TW) 100204918
Jun. 24, 2011 (TW) 100211588

(51) Int. Cl. G06F 3/02; G06F 3/033

(52) U.S. Cl. 345/167; 345/168

(57) ABSTRACT

A monitor is disclosed and includes a displaying device, a supporting device, and a console. The supporting device is connected to and supports the displaying device. The console is connected in communication to the displaying device and is capable of being engaged with the supporting device. The console includes a first switch key and a second switch key. The displaying device can be triggered to switch to a first displaying mode by the first switch key or to a second displaying mode by the second switch key. The detachable design for the console of the invention not only allows a user to quickly switch the displaying modes, but also avoids shaking due to performing the switching on the displaying device by fingers in the prior art. Therefore, the invention can effectively solve the inconvenience of switching or setting the displaying modes in the prior art.

### BACKGROUND OF THE INVENTION

1. Field of the Invention

The invention relates to a monitor, and especially relates to a monitor with a detachable console.

2. Description of the Prior Art

In general, a present monitor has a function of displaying an on-screen display menu for a user to set displaying parameters of the monitor. The user needs keys on the rim of the monitor for the manipulation. In most cases, the user may need to set a plurality of parameters. The setting for each parameter may need several pushes on the keys. So, for an entire setting, the user needs to push the keys a dozen to dozens times, which takes ten to twenty seconds or more. A common user may be tolerant to the above case in a common scenario such as processing documents, seeing movies and other non-real-time scenarios. However, in a scenario that a gamer needs to perform the parameter setting such as changing displaying size or brightness during a real-time game, the gamer is requested to spare one hand, time, and attention for the setting; it is obviously unrealistic.

Furthermore, the body of the user is required to approach the monitor so as to successfully push keys. Pushing keys induces shaking of the whole monitor. These manipulation phenomena are not only inconvenient for common users but also quite bothersome for gamers, even leading to failure in games.

### SUMMARY OF THE INVENTION

An objective of the invention is to provide a monitor, which uses a detachable console to provide a user a setting manipulation close by and has switch keys disposed on the console for a user to switch displaying modes quickly, so as to effectively solve the problems of wasting time and shaking induced by setting the displaying parameters in the prior art.

A monitor according to the invention includes a displaying device, a supporting device, and a console. The supporting device is connected to and supports the displaying device. The console is connected in communication to the displaying device and is capable of being engaged with the supporting device. The console includes a first switch key and a second switch key. The displaying device is capable of being triggered to switch to a first displaying mode by the first switch key. The displaying device is capable of being triggered to switch to a second displaying mode by use of the second switch key. Thereby, the console is capable of being disengaged from the supporting device and the displaying device to a user. Then, the user can use the console to perform manipulation of displaying parameters of the displaying device and also to switch to the first displaying mode and the second displaying mode directly, even to more displaying modes.

Another monitor according to the invention includes a displaying device, a mounting, a support, and an input device. The mounting is disposed on a plane and has a mounting left end and a mounting right end. One of the mounting left end and the mounting right end has an engagement structure. The support is disposed between the displaying device and the mounting. The support supports the displaying device on the mounting. The input device is electrically connected to the displaying device. The mounting is capable of being engaged with the input device by the engagement structure or being departed from the input device selectively. Similarly, a user can depart the input device from the mounting for manipulation close by.

In short, the console according to the invention is designed in a detachable way, so the user can not only quickly switch the displaying modes, but also can avoid the inconvenience of manipulating with being required to be close to the displaying device in the prior art and the problem of the displaying device shaking induced by manipulation by fingers directly on the displaying device in the prior art. Therefore, the invention can effectively solve the problems of wasting time, distraction, shaking, and so on induced by setting or switching the displaying modes in the prior art.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a monitor of a preferred embodiment according to the present invention.

FIG. 2 is a back view of the monitor in FIG. 1.

FIG. 3 is a schematic diagram of the engagement for the mounting and the console of another embodiment according to the present invention.

FIG. 4 is a schematic diagram of the console of the monitor in FIG. 1.

FIG. 5 is a partial section of the console along the cutting line X-X in FIG. 4.

FIG. 6 is a schematic diagram of an on-screen display menu for the displaying parameters of the displaying device of the monitor.

FIG. 7 is a partial section of the console according to another embodiment.

FIG. 8 is a schematic diagram of a monitor of the invention according to another preferred embodiment.

FIG. 9 is a schematic diagram of a monitor of the invention according to another preferred embodiment.

FIG. 10 is a schematic diagram of a monitor of the invention according to another preferred embodiment.

FIG. 11 is a schematic diagram of a monitor of the invention according to another preferred embodiment.

### DETAILED DESCRIPTION

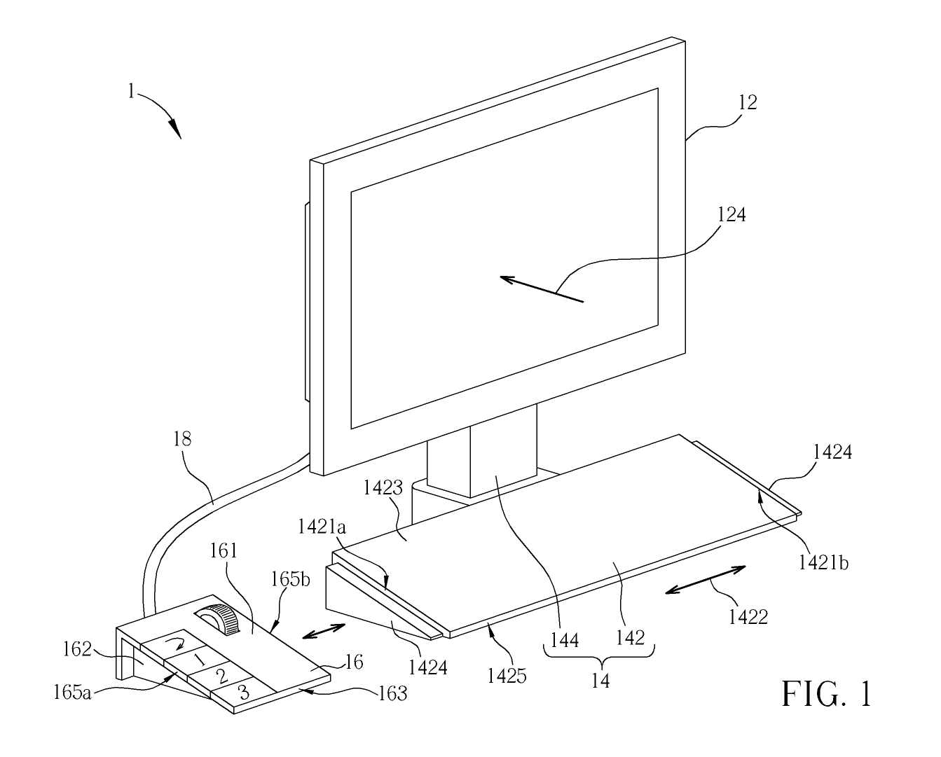

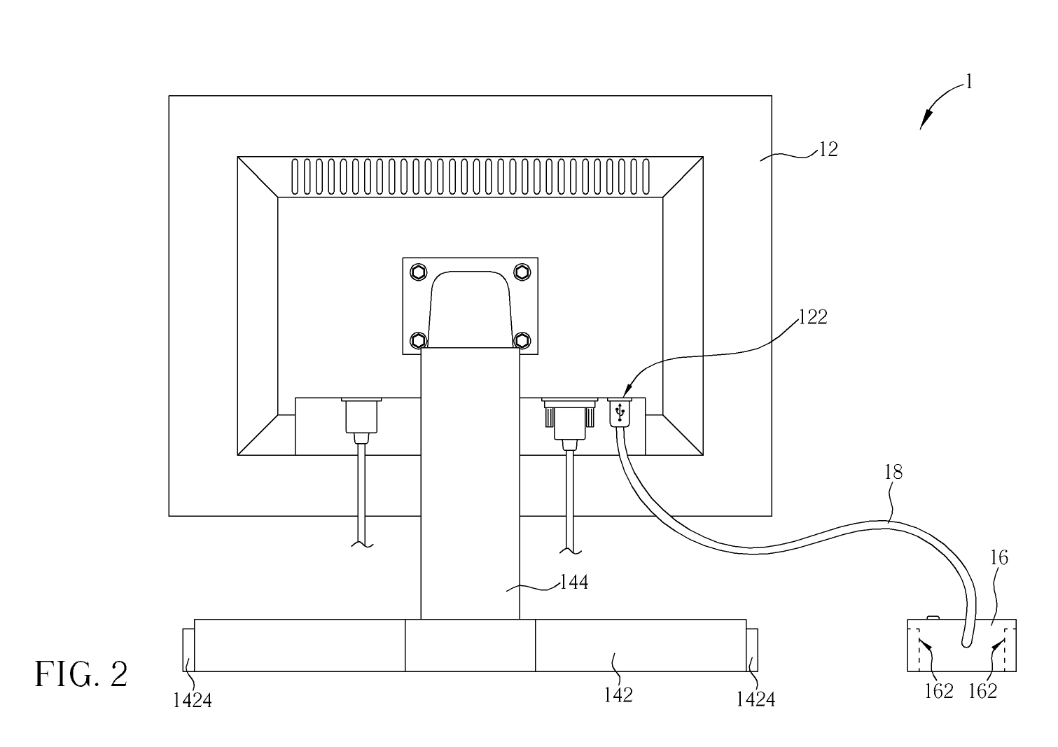

Please refer to FIG. 1 and FIG. 2. FIG. 1 is a schematic diagram of a monitor 1 of a preferred embodiment according to the present invention. FIG. 2 is a back view of the monitor 1. The monitor 1 includes a displaying device 12, a supporting device 14, and a console 16 (or other input device, the invention is not limited to it). The supporting device 14 is connected to and supports the displaying device 12. The console 16 is connected in communication to the displaying device 12 and is capable of being engaged with the supporting device 14. In the embodiment, the console 16 is electrically connected to a universal serial bus connection port 122 of the displaying device 12 by a cable 18. However, the invention is not limited to this; the console 16 is alternatively capable of being connected to the displaying device 12 through any other connection ports, even through a wireless connection.

The supporting device 14 includes amounting 142 and a support 144. The support 144 is disposed between the displaying device 12 and the mounting 142. The mounting 142 can be placed on a plane (not shown in the figure) such as tabletop; however, the invention is not limited to it. The displaying device 12 is supported by the support 144. The displaying device 12 thereon defines a view direction 124; correspondingly, the mounting 142 thereon defines a disposition direction 1422 perpendicular to the view direction 124. The mounting 142 includes an engagement structure 1424 along the disposition direction 1422 on each of two sides of the mounting 142. In other words, the mounting 142 has a mounting left end 1421a and a mounting right end 1421b. Each of the mounting left end 1421a and the mounting right end 1421b has the engagement structure 1424. Thereby, the console 16 is capable of being engaged with the supporting device 14 by either of the engagement structures 1424, or being departed from the mounting 142. There are two of the engagement structures 1424 in the embodiment; hence, a user is able to choice either of the engagement structures 1424 by his habit to engage. That is, the user can use his left or right hand to engage the console 16 to the mounting 142 by the left or right side. However, for the disposition, quantity, and geometric structure of the engagement structure 1424, the invention is still not limited to the above disclosure.

It is added that, in the embodiment, the mounting 142 has a mounting top surface 1423. The console 16 has an input-device top surface 161. When the mounting 142 is engaged with the console 16 by the engagement structure 1424, the mounting top surface 1423 and the input-device top surface 161 are coplanar. Furthermore, the mounting 142 has a mounting front edge 1425. The console 16 has an input-device front edge 163. Similarly, when the mounting 142 is engaged with the console 16 by the engagement structure 1424, the mounting front edge 1425 is aligned with the input-device front edge 163. In addition, as the engagement direction of the console 16 and the mounting 142 shown in FIG. 1, the console 16 has an input-device left end 165a and an input-device right end 165b. There is one of the engagement structures 1424 at the mounting left end 1421a. The input-device right end 165b is capable of being engaged with the mounting left end 1421a by the engagement structure 1424 at the mounting left end 1421a, while the input-device left end 165a has a plurality of buttons (i.e. the buttons marked with numbers ‘1’, ‘2’ and ‘3’ and a return symbol).

In the embodiment, the engagement structure 1424 is a protrusion basically; the console 16 has a depression 162 correspondingly (shown in dashed lines in FIG. 2). The console 16 realizes the engagement purpose of the console 16 and the supporting device 14 by the joining the depression 162 and the protrusion together. In practice, the protrusion may include some structure features thereon so that the depression 162 and the protrusion can be joined tight. For example, the engagement sections of the protrusion and the depression 162 can be designed to be more complex in geometry so as to increase the contact area between the protrusion and the depression 162; or the protrusion thereon forms ribs (the extension direction of which is non-parallel to the disposition direction 1422) while the depression 162 forms corresponding slots inside, so as to produce the effect of holding. Furthermore, because the console 16 has depressions 162 on the both sides, the user can engage the console 16 with the mounting 142 by either engagement structure 1424 on different side; however, the invention is not limited to this. It is added that, in practice, the engagement structure 1424 can be a depression, and the console 16 includes a protrusion correspondingly for being engaged with the depression. Please refer to the above description for the engagement herein, which is no longer to be discussed more. In addition, the engagement mechanism using geometric structure has the effect of positioning, so by the design of appearance dimensions of the console 16 and the mounting 142, the whole profile of the console 16 engaged with the mounting 142 together is continuous and smooth to show an integral whole, which improves the appearance of the product.

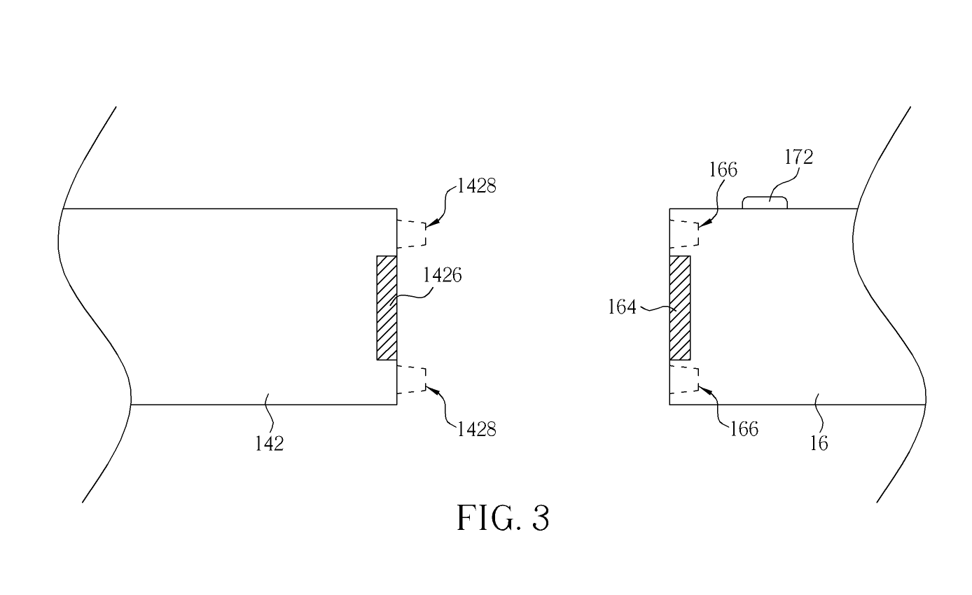

Please refer to FIG. 3, which is a schematic diagram of the engagement for the mounting 142 and the console 16 of another embodiment according to the present invention. In this embodiment, there is no engagement structure meshing with each other for the mounting 142 and the console 16. However, the mounting 142 and the console 16 includes magnetic parts 1426 and 164 respectively, so the console 16 is capable of being mounted on the mounting 142 by use of the magnetic attraction induced by the magnetic parts 1426 and 164. In practice, the magnetic parts 1426 and 164 can be disposed outside or inside the mounting 142 and the console 16, even integrated into a part of the case thereof. The magnetic parts 1426 and 164 can be made of magnetic material; or one of the magnetic parts 1426 and 164 is a magnet, and the other is made of magnet-conductive material. However, the invention is not limited to this. In this embodiment, there is no engagement structure meshing with each other, so the user to attach the console 16 on the mounting 142 more easily. In addition, in practice, for the advantages of the alignment accuracy of physical geometric structure and the convenience of magnetic engagement, a meshing structure such as pyramids 1428 and holes 166 (shown in dashed lines) for guiding the engagement may be added to the engagement interface in FIG. 3. It is added that, in the engagement mechanism shown in FIG. 2, magnets may be disposed in the engagement structures 1424 and the depressions 162 respectively to improve the engagement stability of the console 16 and the mounting 142.

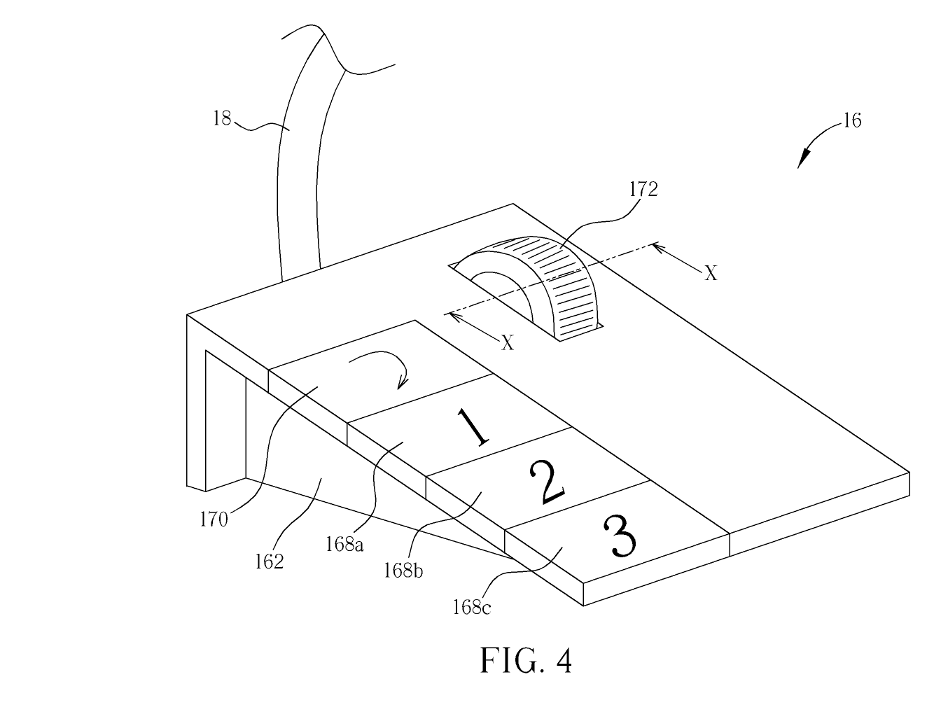

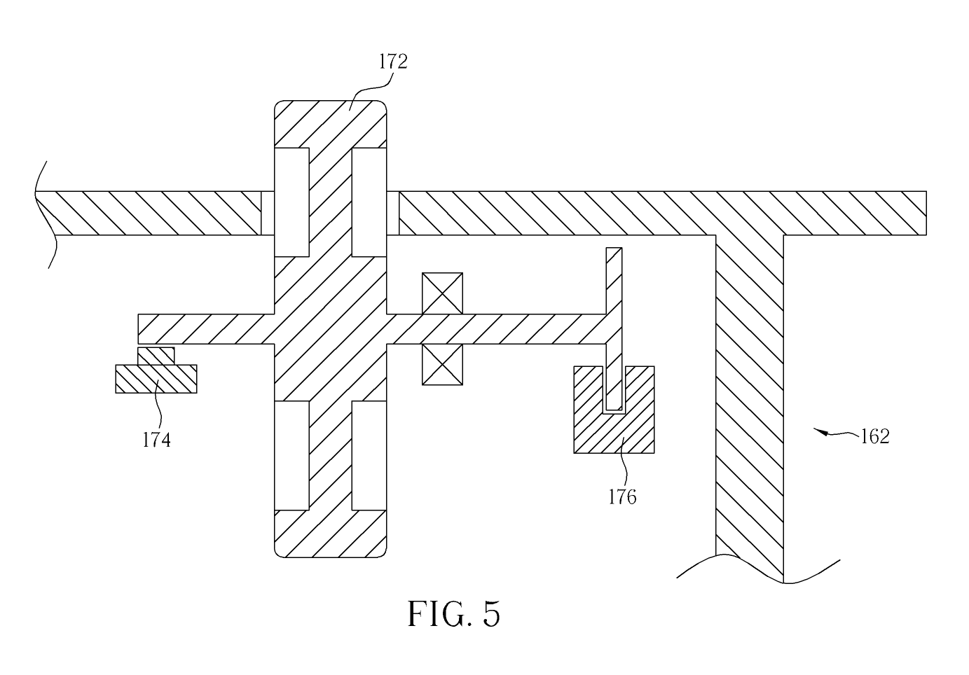

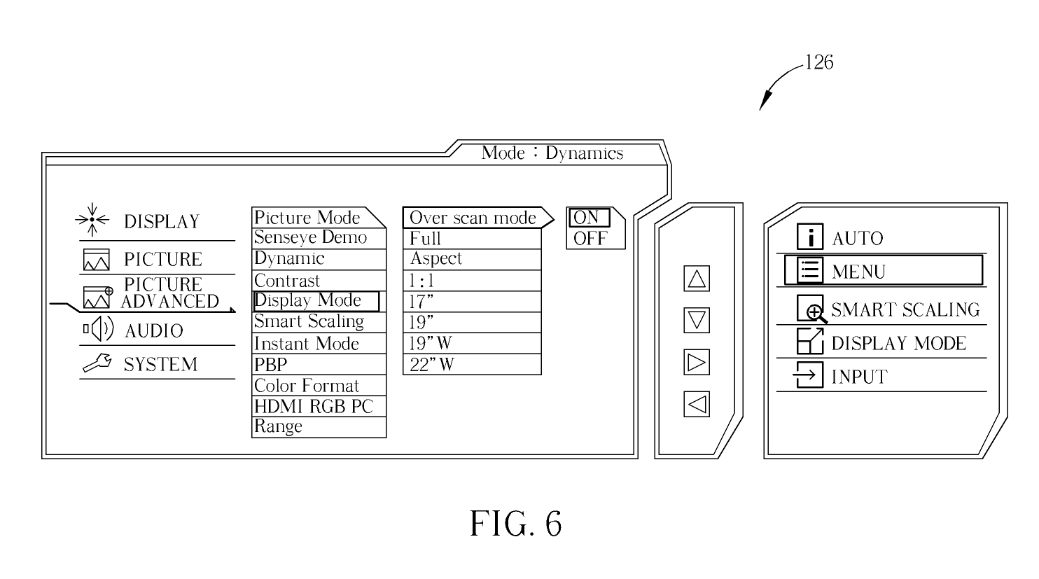

Please refer to FIG. 4 and FIG. 5. FIG. 4 is a schematic diagram of the console 16 of the monitor 1 in FIG. 1. FIG. 5 is a partial section of the console 16 for showing the interior thereof; the position of the cutting plane for the section is shown as the cutting line X-X in FIG. 4 substantially. The console 16 includes three switch keys 168a, 168b ad 168c, a back key 170, a rotary part 172, and a confirmation key 174. In the embodiment, the rotary part 172 is a rotary wheel, the rotation of which is sensed by use of a sensor 176. The confirmation key 174 is disposed below the shaft of the rotary part 172 (as shown in FIG. 5). The rotary part 172 can be pressed down to trigger the confirmation key 174. A user can set the displaying parameters, including sizes, brightness, saturation, contrast, horizontal position, vertical position and so on, of the displaying device 12 by use of the back key 170, the rotary part 172 and the confirmation key 174. For a general setting operation, an on-screen display menu 126 relative to the displaying parameters of the displaying device is shown as in FIG. 6. In the embodiment, the on-screen display menu 126 is a nest structure to be displayed in single list, which is conducive to selecting by use of the rotary wheel; however, the invention is not limited to this.

Furthermore, in practice, there are displaying parameters having been stored in advance correspondingly to each of the switch keys 168a, 168b and 168c. If any one of the switch keys 168a, 168b and 168c is triggered (such as by pressing), the displaying device 12 will be switched to a displaying mode relative to the displaying parameters corresponding to the pressed switch key 168a, 168b or 168c. In the embodiment, the user can also use the back key 170, the rotary part 172, and the confirmation key 174 to set the displaying parameters correspondingly to the switch keys 168a, 168b and 168c respectively. For example, when the user has set the displaying parameters by use of the on-screen display menu 126, the user can press any one of the switch keys 168a, 168b and 168c for some time (for example 5 seconds or any other set time) to store the present displaying parameters corresponding to the pressed switch key 168a, 168b or 168c. In addition, according to a program design, the user can press anyone of the switch keys 168a, 168b and 168c for some time (for example 10 seconds or any other set time, usually longer than the time for storing abovementioned) to restore a default displaying parameters corresponding to the pressed switch key 168a, 168b or 168c. In sum, the switch keys 168a, 168b and 168c corresponds to different displaying parameters respectively. Anyone of the switch keys 168a, 168b and 168c can be triggered (such as by pressing) for switching the displaying device 12 to operate in the displaying mode relative to the displaying parameters corresponding to the pressed switch key 168a, 168b or 168c. Therefore, in the embodiment, the displaying device 12 has at least three displaying modes; for example, except for the original displaying modes corresponding to the switch keys 168a, 168b and 168c, the switch keys 168a, 168b and 168c can be triggered together with the back key 170 for switching more displaying modes. In practice, the above-mentioned displaying modes can be a bright displaying mode, a predetermination-sized displaying mode, a theater displaying mode, a game displaying mode, a darkroom displaying mode, a document-processing displaying mode and so on.

It is added that the operation design for the keys (including the switching keys 168a, 168b and 168c, the back key 170, the rotary part 172, and the confirmation key 174) can involve more functions depending on different program designs to satisfy different demands. Further, the invention is not limited to controlling the displaying modes of the displaying device 12. For example, the invention is also applied to interactive manipulations on the displaying content of the displaying device 12. The above is not described one by one herein. In addition, in practice, the operation for triggering the switch keys 168a, 168b and 168c is not limited to pressing; for example, if the switch keys 168a, 168b and 168c are realized by a touch panel, the triggering can be performed by touching the touch panel. Furthermore, in practice, the user can remove the console 16 from the mounting 142 to approach his body for convenient operation; alternatively, the user can reach his hands for operation, which does not trouble the user much. Anyway, the user can operate easily to switch the displaying modes for the displaying device 12 by use of the switch keys 168a, 168b and 168c without the problem of the on-screen display menu 126 shadowing the screen, which solves the problem of inconvenience, wasting time, distraction and so on during the switching in the prior. Besides, the console 16 does not directly contact the displaying device 12, so the hands of the user will not affect the displaying device 12 during the operation on the console 16 and the shaking problem in the problem is therefore avoided.

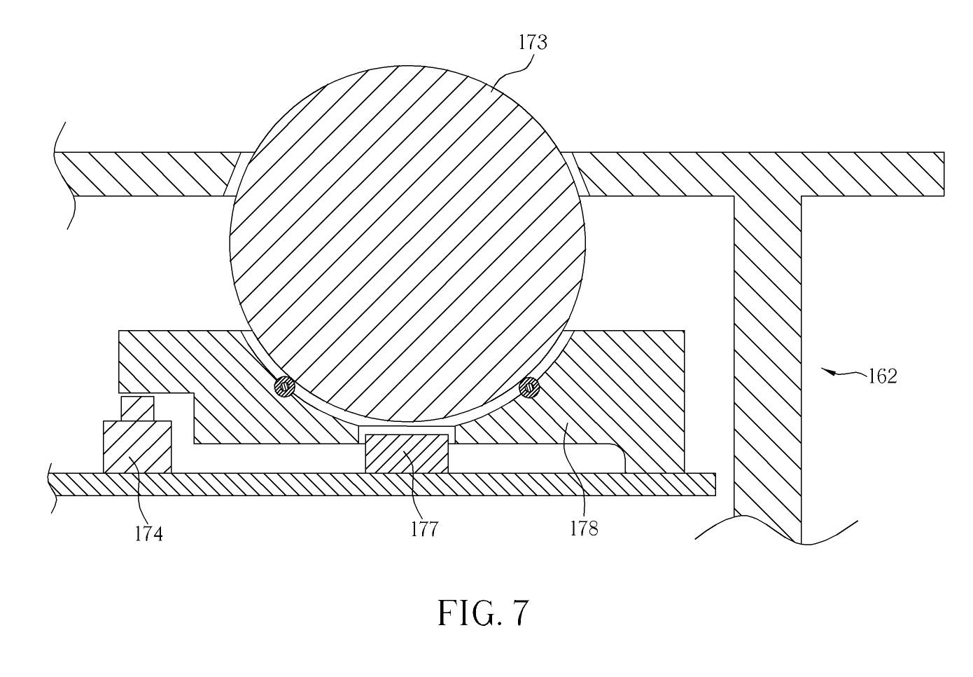

Please refer to FIG. 7, which is a partial section of the console 16 according to another embodiment for showing the interior thereof. Compared with the console 16 in FIG. 5, in this embodiment, the rotary part of the console 16 in FIG. 7 is a trackball 173 and the sensor of console 16 is a photo-sensor 177 for sensing the two-dimensional rolling of the trackball 173. The carrier 178 for carrying the trackball 173 shows a cantilever structure (or other elastic structures). The confirmation key 174 is disposed under the free end of the carrier 178 such that the trackball 173 can be pressed to make the carrier 178 press down the confirmation key 174, and the operation of triggering the confirmation key 174 is therefore completed. It is added that the trackball 173 can provide pointer operation of two-dimensional movement, so the on-screen display menu 126 (as shown in FIG. 6) can be displayed in an arrangement of multiple lists in this embodiment, and the user can perform selection and setting by use of the trackball 173.

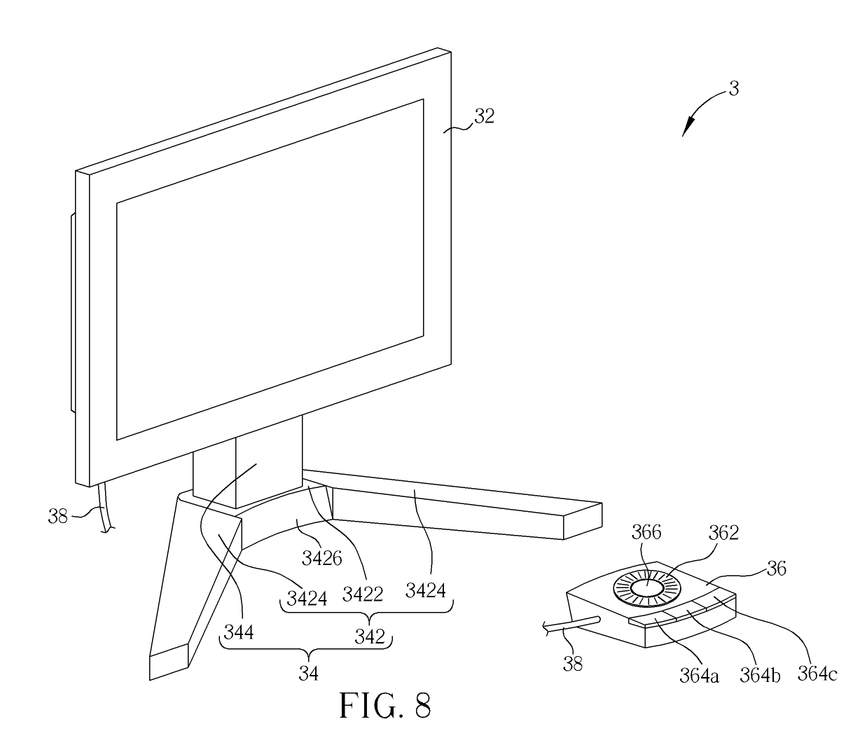

In the above embodiments, they are illustrated for the invention by the supporting device 14 mainly consisting of the single mounting 142 and the single support 144; however, the invention is not limited to this. Please refer to FIG. 8, which is a schematic diagram of a monitor 3 of the invention according to another preferred embodiment. A mounting 342 of a supporting device 34 of the monitor 3 includes a base 3422 and two feet 3424. The two feet 3424 are symmetrically connected to the base 3422. A support 344 of supporting device 34 is connected to the base 3422. An engagement structure 3426 of the mounting 342 is disposed on the base 3422 between the two feet 3424. A displaying device 32 of the monitor 3 is connected to the support 344. A console 36 is connected in communication to the displaying device 32 by a cable 38 and is capable of being disposed between the two feet 3424 to be connected to the engagement structure 3426. In the embodiment, the engagement structure 3426 is a wedge structure where the console 36 has a corresponding wedge structure to be connected. Similarly, the engagement structure 3426 can be replaced with magnetic parts so that the magnetic attraction replaces the structure constraint, or the engagement structure 3426 further includes magnetic parts therein for the both advantages. The above-mentioned explanation for the engagement structure and the magnetic part is also applied herein, which is not repeated. It is added that the rotary part of the console 36 is a rotary wheel 362. A confirmation key is disposed under the rotary wheel 362 and is capable of being triggered by pressing the rotary wheel 362. An applicable structure for the confirmation key can be easily realized according to the description of the above embodiments, which will not be described. Switch keys 364a, 364b and 364c of the console 36 are disposed at a side of the main body of the console 36. A back key 366 of the console 36 is disposed in the hollow portion of the rotary wheel 362. Regarding descriptions for other components of the monitor 3, please refer to the relevant descriptions mentioned above of the components with the same names of the monitor 1, which will not be repeated.

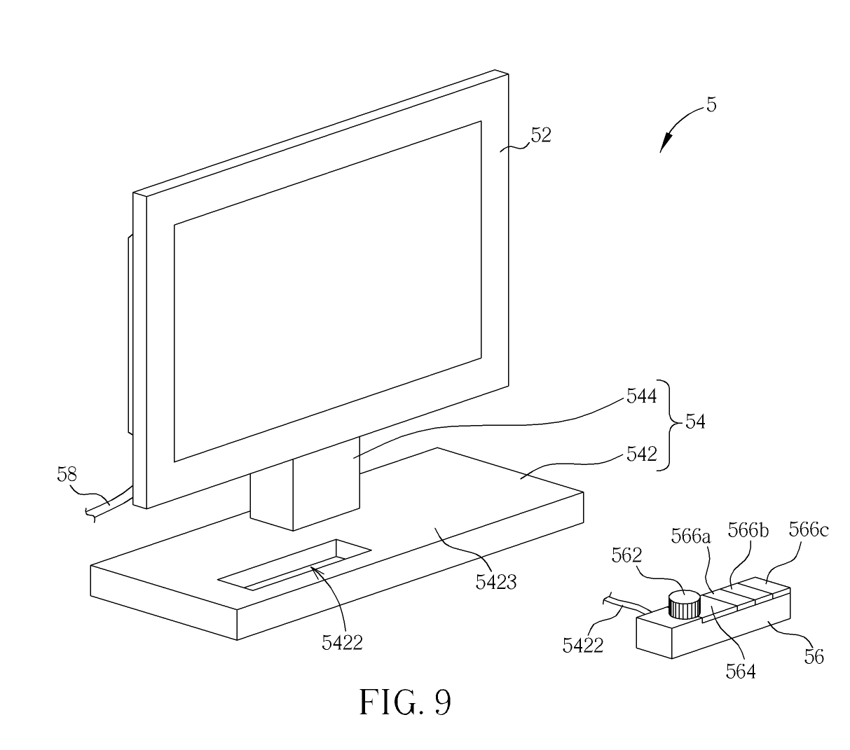

Please refer to FIG. 9, which is a schematic diagram of a monitor 5 of the invention according to another preferred embodiment. A displaying device 52 of the monitor 5 is connected to a support 544 of a supporting device 54 of the monitor 5. A mounting top surface 5423 of a mounting 542 of the supporting device 54 of the monitor thereon forms a rectangle depression slot 5422 having an accommodating space, regarded as the engagement structure for accommodating a console 56. Thereby, the console 56 can be accommodated in the accommodating space or be taken out of the accommodating space selectively. In the embodiment, the profile of the rectangle depression slot 5422 matches the profile of the console 56; however, the invention is not limited to this. The console 56 and displaying device 52 are connected in communication with a cable 58. The rotary part of the console 56 is a rotary wheel 562. Directly pressing the rotary wheel 562 can trigger a confirmation key of the console 56. The rotary wheel 562, a back key 564, and switch keys 566a, 566b and 566c are arranged in order on the main body of the console 56. Regarding descriptions for other components of the monitor 5, please refer to the relevant descriptions mentioned above of the components with the same names of the monitor 1, which will not be repeated. It is added that, in practice, the rectangle depression slot 5422 can be a through hole passing through the mounting 542 with a bottom directly by the top of a desk; therefore, the console 56 can still be accommodated in the rectangle depression slot 5422 stably.

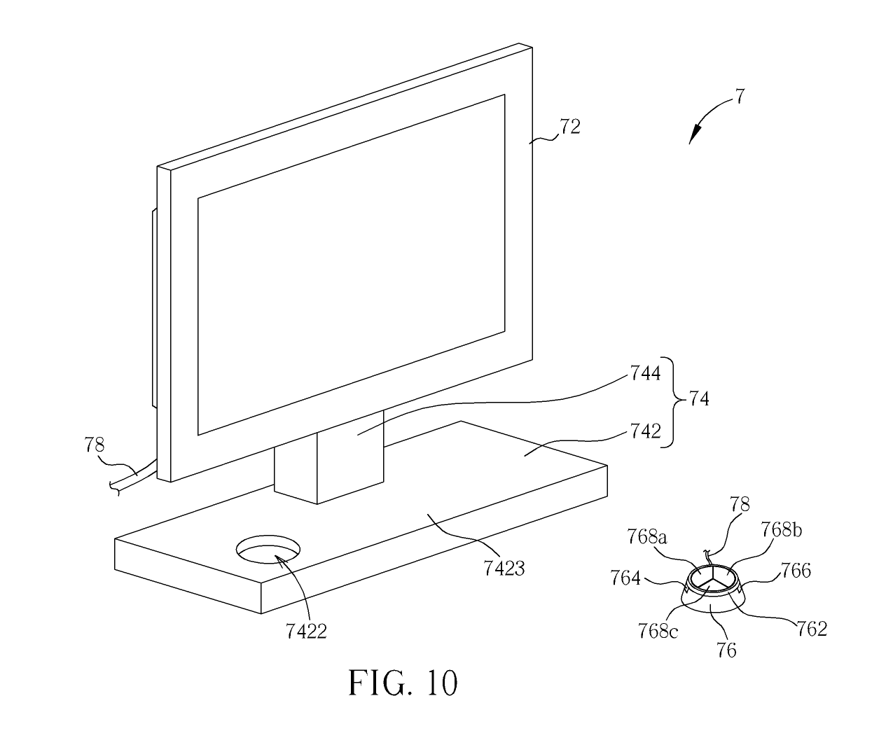

Please refer to FIG. 10, which is a schematic diagram of a monitor 7 of the invention according to another preferred embodiment. A displaying device 72 of the monitor 7 is connected to a support 744 of a supporting device 74 of the monitor 7. Amounting top surface 7423 of a mounting 742 of the supporting device 74 of the monitor thereon forms a circular depression slot 7422 having an accommodating space, regarded as the engagement structure for accommodating a console 76. Thereby, the console 76 can be accommodated in the accommodating space or be taken out of the accommodating space selectively. In the embodiment, the profile of the circular depression slot 7422 matches the profile of the console 76; however, the invention is not limited to this. The console 76 and displaying device 72 are connected in communication with a cable 78. The rotary part of the console 76 is a rotary wheel 762. A confirmation key 764 and a back key 766 of the console 76 are disposed at two sides of the main body of the console 76 respectively. Switch keys 768a, 768b and 768c are disposed in the hollow portion of the rotary wheel 762. Regarding descriptions for other components of the monitor 7, please refer to the relevant descriptions mentioned above of the components with the same names of the monitors 1 and 5, which will not be repeated.

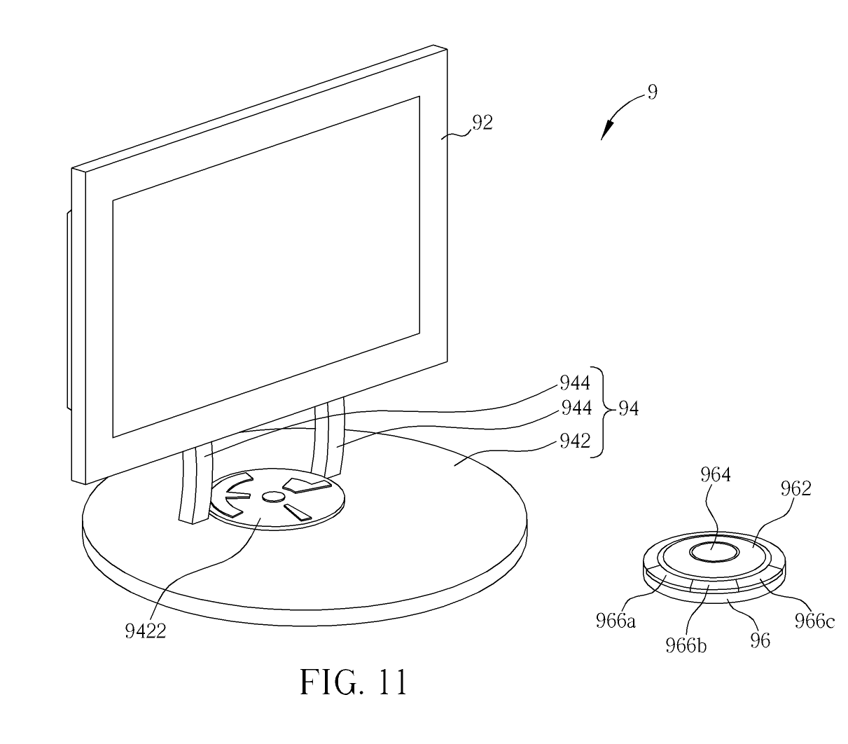

Please refer to FIG. 11, which is a schematic diagram of a monitor 9 of the invention according to another preferred embodiment. A support 944 of a supporting device 94 of the monitor 9 consists mainly of two pillars. A displaying device 92 of the monitor 9 is connected to the support 944. A mounting 942 of the supporting device 94 thereon forms a circular protrusive pedestal 9422 as the engagement structure for accommodating a console 96, slightly protruding out the mounting 942 between the two pillars. In the embodiment, the circular protrusive pedestal 9422 forms a protrusion-and-depression structure thereon. The bottom of the console 96 thereon forms a corresponding protrusion-and-depression structure (not shown in the figure) for engaging with the circular protrusive pedestal 9422. Such design can also achieve the engagement of the console with the supporting device. Furthermore, in the embodiment, the console 96 and the displaying device 92 transit signals by wireless communication, which saves a cable for electrical connection so that the appearance of the monitor 9 is simpler. The rotary part of the console 96 is a rotary wheel 962. Directly pressing the rotary wheel 962 can trigger a confirmation key of the console 96. The rotary wheel 962, a back key 964, and switch keys 966a, 966b and 966c are adjacent to be arranged at the circumference of the main body of the console 96. Regarding descriptions for other components of the monitor 9, please refer to the relevant descriptions mentioned above of the components with the same names of the monitors 1 and 5, which will not be repeated.

It is added that, the above embodiments are exampled illustrated for the invention by the console capable of being engaged with the mounting of the supporting device; however, the invention is not limited to this. For example, the console can also hang on the support. In this case, the console does not physically contact the displaying device either, so manipulation on the console on the support does not induce any noticeable shaking of the displaying device.

As discussed above, compared to the prior art, the console of the invention is designed to be detachable, so that the user can remove the console from the supporting device for manipulation close by or can manipulate the console when the console is still engaged with the supporting, which depends on the user's habits. No matter which the user takes, the invention can provide the user convenient setting manipulation and quick switching manipulation; moreover, the console does not physically contact the displaying device, so the manipulation does not induce any noticeable shaking of the displaying device. Therefore, the invention can effectively solve the problems of wasting time, distraction, shaking, and soon induced by setting or switching the displaying modes in the prior art.

Those skilled in the art will readily observe that numerous modifications and alterations of the device and method may be made while retaining the teachings of the invention.

1. A monitor, comprising:
a displaying device;
a supporting device, the supporting device being connected to and supporting the displaying device; and
a console, the console being connected in communication to the displaying device and being capable of being engaged with the supporting device, the console comprising a first switch key and a second switch key, the displaying device being capable of being triggered to switch to a first displaying mode by use of the first switch key, the displaying device being capable of being triggered to switch to a second displaying mode by use of the second switch key.

2. The monitor of claim 1, wherein the supporting device comprises a mounting and a support, the mounting comprises an engagement structure, and the console is capable of being engaged with the supporting device by the engagement structure.

3. The monitor of claim 2, wherein the displaying device thereon defines a view direction, and the engagement structure is disposed on a side of the mounting in a direction substantially perpendicular to the view direction.

4. The monitor of claim 3, wherein the engagement structure comprises a first protrusion or a first depression, the console correspondingly comprises a second depression or a second protrusion, the first protrusion is capable of being engaged with the second depression, and the first depression is capable of being engaged with the second protrusion.

5. The monitor of claim 3, wherein the engagement structure comprises a first magnetic part, the console comprises a second magnetic part, and the console is capable of being attached on the mounting by magnetic attraction induced by the first magnetic part and the second magnetic part.

6. The monitor of claim 2, wherein the mounting comprises a base and two feet, the feet are symmetrically connected to the base, the support is connected to the base, and the engagement structure is disposed between the feet and on the base.

7. The monitor of claim 2, wherein the engagement structure is a depression slot, a protrusive pedestal, or an accommodating space with protrusion-and-depression structure, and a profile of the depression slot, the protrusive pedestal, or the accommodating space with protrusion-and-depression structure matches with a profile of the console, such that the console is capable of being accommodated on an upper surface of the mounting.

8. The monitor of claim 1, wherein the console is electrically connected to a universal serial bus connection port of the displaying device by a cable.

9. The monitor of claim 1, wherein the console further comprises a rotary part, a confirmation key, and a back key, for setting displaying parameters of the displaying device, and the first displaying mode and the second displaying mode can be set by manipulating the rotary part, the confirmation key, and the back key.

10. The monitor of claim 9, wherein the rotary part is a roller, a rotary wheel, or a trackball, the confirmation key is disposed near the rotary part, and the confirmation key is triggered by pressing the rotary part.

11. The monitor of claim 9, wherein an on-screen display menu relative to the displaying parameters of the displaying device is a nested structure and is displayed in a single-list way.

12. The monitor of claim 1, wherein the first displaying mode is a bright displaying mode, and the second displaying mode is a predetermination-sized displaying mode.

13. A monitor, comprising:
a displaying device;
a mounting, disposed on a plane, the mounting having a mounting left end and a mounting right end, one of the mounting left end and the mounting right end having an engagement structure;
a support, disposed between the displaying device and the mounting, the support supporting the displaying device on the mounting; and
an input device, electrically connected to the displaying device, the mounting being capable of being engaged with the input device by the engagement structure or being departed from the input device selectively.

14. The monitor of claim 13, wherein the mounting has a mounting top surface, the input device has an input-device top surface, and when the mounting is engaged with the input device by the engagement structure, the mounting top surface and the input-device top surface are coplanar.

15. The monitor of claim 13, wherein the mounting has a mounting front edge, the input device has an input-device front edge, and when the mounting is engaged with the input device by the engagement structure, the mounting front edge is aligned with the input-device front edge.

16. The monitor of claim 13, wherein the input device has an input-device left end and an input-device right end, the input-device right end is engaged with the mounting left end by the engagement structure, and the input-device left end has a plurality of buttons.

17. The monitor of claim 13, wherein the engagement structure comprises a first protrusion or a first depression, the input device correspondingly comprises a second depression or a second protrusion, the first protrusion is capable of being engaged with the second depression, and the first depression is capable of being engaged with the second protrusion.

18. The monitor of claim 13, wherein the engagement structure comprises a first magnetic part, the input device comprises a second magnetic part, and the input device is capable of being attached on the mounting by magnetic attraction induced by the first magnetic part and the second magnetic part.

19. The monitor of claim 13, wherein the mounting has a mounting top surface, the engagement structure is an accommodating space formed on the mounting top surface, and the input device is capable of being accommodated in the accommodating space or being taken out of the accommodating space selectively.

20. A method of displaying a content on a displaying device, the method comprising:
providing an on-screen display menu listing displaying parameters, the displaying parameters comprising a full size parameter and at least one non-aspect predetermined displaying size parameter;
selecting one of the non-aspect predetermined displaying size parameter; and
displaying the content on the displaying device according to the selected non-aspect predetermined displaying size parameter.

21. The method of claim 20, wherein a displaying area according to the non-aspect predetermined displaying size parameter is smaller than a displaying area according to the full size parameter.

22. The method of claim 20, wherein the on-screen display menu lists the non-aspect predetermined displaying size parameter by showing a size in inches for the non-aspect predetermined displaying size parameter.

23. The method of claim 20, wherein the selected non-aspect predetermined displaying size parameter is one selected from the group consisting of 17″, 19″, 19″W and 22″W.

24. The method of claim 20, wherein the non-aspect predetermined displaying size parameter listed on the on-screen display menu comprises a wording 19″.

25. The method of claim 20, wherein the on-screen display menu relative to the full size parameter and the non-aspect predetermined displaying size parameter is in a nested structure and is displayed in a single-list way.

26. The method of claim 20, further comprising:
switching an original displaying mode to a displaying mode in conformity with the selected non-aspect predetermined displaying size parameter.

27. The method of claim 20, further comprising:
storing the selected non-aspect predetermined displaying size parameter in a displaying mode.

28. The method of claim 27, further comprising:
restoring the stored displaying mode or an original displaying mode to display the content.

29. The method of claim 27, further comprising:
providing an input device electrically connected to the displaying device and capable of being engaged with the displaying device or being departed from the displaying device selectively, wherein the input device is operated to switch displaying modes, and the displaying modes comprises an original displaying mode and the stored displaying mode.

30. The method of claim 27, further comprising:
providing an input device wirelessly electrically connected to the displaying device, wherein the input device is operated to switch displaying modes, and the displaying modes comprises an original displaying mode and the stored displaying mode.

31. The method of claim 20, further comprising:
providing an input device electrically connected to the displaying device and capable of being engaged with the displaying device or being departed from the displaying device selectively, wherein the input device is operated to select one of the non-aspect predetermined displaying size parameter.

32. The method of claim 20, further comprising:
providing an input device wirelessly electrically connected to the displaying device, wherein the input device is operated to select one of the non-aspect predetermined displaying size parameter.

33. A monitor, comprising:
a displaying device capable of displaying an on-screen display menu listing displaying parameters, the displaying parameters comprising a full size parameter and at least one non-aspect predetermined displaying size parameter; and
a console electrically connected to the displaying device and capable of being operated to select one of the non-aspect predetermined displaying size parameter,
wherein the displaying device displays a content according to the selected non-aspect predetermined displaying size parameter.

34. The monitor of claim 33, wherein a displaying area according to the non-aspect predetermined displaying size parameter is smaller than a displaying area according to the full size parameter.

35. The monitor of claim 33, wherein the on-screen display menu lists the non-aspect predetermined displaying size parameter by showing a size in inches for the non-aspect predetermined displaying size parameter.

36. The monitor of claim 33, wherein the selected non-aspect predetermined displaying size parameter is one selected from the group consisting of 17″, 19″, 19″W and 22″W.

37. The monitor of claim 33, wherein the non-aspect predetermined displaying size parameter listed on the on-screen display menu comprises a wording 19″.

38. The monitor of claim 33, wherein the on-screen display menu relative to the full size parameter and the non-aspect predetermined displaying size parameter is in a nested structure and is displayed in a single-list way.

39. The monitor of claim 33, wherein the console comprises a switch key capable of being triggered to switch displaying modes of the displaying device.

40. The monitor of claim 39, wherein the console further comprises a rotary part, a confirmation key, and a back key, for setting displaying parameters of the displaying device, and the displaying modes can be set by manipulating the rotary part, the confirmation key, and the back key.

41. The monitor of claim 39, wherein a displaying parameter of a first displaying mode is stored correspondingly to the switch key in advance, and when the switch key is triggered in a first predetermined period, a displaying parameter of an original displaying mode is stored correspondingly to the switch key.

42. The monitor of claim 41, wherein when the switch key is triggered in a second predetermined period, the displaying parameter of the first displaying mode is restored correspondingly to the switch key, and the second predetermined period is longer than the first predetermined period.
